(19) United States
(12) Patent Application Publication
(10) Pub. No.: US 2007/0200701 A1
(43) Pub. Date: Aug. 30, 2007

(54) Network centric sensor fusion for shipping container security

(76) Inventors: Kent L. English, St. Charles, MO (US); Christopher K. Zuver, St. Charles, MO (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/364,632

(22) Filed: Feb. 27, 2006

(51) Int. Cl. G08B 13/14; G05B 19/00

(52) U.S. Cl. 340/572.1; 340/5.61

(57) ABSTRACT

A method of monitoring an entrance to a cargo container, comprising the following steps: (a) creating a entry record for each item of cargo loaded into a cargo container; (b) creating an ID record for each RFID tag that enters the cargo container during loading of the items of cargo; and (c) correlating the video and ID records to raise an alarm if an item of cargo is loaded without an authorized RFID tag attached thereto.

### BACKGROUND OF THE INVENTION

The present invention relates generally to the field of shipping or cargo container security.

The worldwide ocean-going freight transportation infrastructure is vulnerable to terrorism. The open movement of containerized cargo presents an opportunity for terrorists to cause large-scale economic damage, for example, by smuggling a thermonuclear device or radioactive material for a “dirty bomb” into a target country in a shipping container. Consequently, there is a need to develop and deploy tracking and monitoring technologies at the container level to help secure the global supply chain and critical port facilities.

Ultimately, local port facilities should be linked to a regional center and/or national center with potential for international expansion. Consequently, there is a need to adopt technologies, such as geographic information systems (GIS), global satellite communications, the internet, and wireless monitoring/tracking/security infrastructure in managing/securing the supply chain, preferably adopting an open-systems architecture to allow multiple public and private entities to participate.

The U.S. Customs and Border Protection (CBP), an agency of the U.S. Department of Homeland Security, is charged with preventing terrorists and terrorist weapons from entering the United States. With nearly 7 million containers arriving in the United States annually, CBP cannot inspect every container. The majority of containers are low value with very limited monitoring capability. The chain of custody starts with security at the factory and port. Thereafter continuous container monitoring must ensure an unbroken chain of custody.

Homeland Defense initiatives are pushing the first line of defense from American soil to foreign soil. The long-range goal is to secure loading docks in foreign countries, which are key components for reducing the vulnerabilities to supply chain. The Homeland Defense Container Security Initiative (CSI) and Customs-Trade Partners Against Terrorism (C-TPAT) dictate means to identify authorized handlers and cargo. More specifically, means are needed to identify cargo and handlers entering the shipping container and ensure they are authorized. In addition, it may be necessary to receive sensor events from container security devices and fuse this data with other sensor data to minimize false alarm rates and improve overall security effectiveness. On foreign loading docks, it is not always possible to secure the area around the shipping container using physical means.

There is a need for a technical solution that will minimize the vulnerability of shipping containers on foreign or domestic loading docks.

### BRIEF DESCRIPTION OF THE INVENTION

The invention is directed to methods of monitoring an entrance to a cargo container to maintain container security. The method uses sensor fusion to reduce false alarms while increasing the overall security effectiveness.

One aspect of the invention is a method of monitoring an entrance to a cargo container, comprising the following steps: (a) monitoring a space at the entrance of a cargo container to detect whether or not any object or any person has entered the space; (b) transmitting a respective signal each time that any object or any person enters the space during step (a), each respective signal containing data indicating entry by a respective object or person; (c) during step (a), monitoring the space to detect whether or not any authorization device has entered the space; (d) transmitting a respective signal each time that any authorization device enters the space during step (c), each respective signal containing data indicating entry by a respective authorization device; (e) receiving the transmitted signals at a data processor; and (f) processing the data in the transmitted signals at the data processor to identify any lack of correlation between objects or persons and authorization devices entering the space.

Another aspect of the invention is a method of monitoring an entrance to a cargo container, comprising the following steps: (a) creating a entry record for each item of cargo that passes through a space at the entrance of a cargo container during a period of time; (b) creating an ID record for each RFID tag that enters the space during said period of time; and (c) correlating the video and ID records to raise an alarm if an item of cargo passes through the space without an authorized RFID tag entering the space.

A further aspect of the invention is a method of monitoring an entrance into a cargo container during loading, comprising the following steps: (a) arranging a camera so that its field of view is directed at the entrance; (b) arranging one or more antennae at or near the entrance; (c) using the camera to acquire video data representing images of cargo entering or exiting the cargo container; (d) processing the video data into cargo entry data indicating the entry of cargo into the cargo container; (e) using the antennae to acquire cargo ID data from successive cargo RFID tags entering or leaving the cargo; (f) correlating the cargo ID data with the cargo entry data; and (g) transmitting an alarm signal if cargo without valid cargo ID data has been loaded into the cargo container.

Yet another aspect of the invention is an intelligent switch comprising: means for receiving radio signals; and a processor connected to the radio signal receiving means and programmed, after the radio signal receiving means has received radio signals including first data indicating times when items of cargo were loaded into a cargo container and radio signals including second data indicating times when authorized RFID tags entered the cargo container, to correlate the first data with the second data, and then issue an alarm signal if a cargo item has been loaded into the cargo container without entry of an authorized RFID tag into the cargo container.

Other aspects of the invention are disclosed and claimed below.

### BRIEF DESCRIPTION OF THE DRAWINGS

FIG. 1 is a schematic showing a cargo container being monitored during loading by video and RFID sensors in accordance with one embodiment of the present invention.

FIG. 2 is a block diagram showing a system for monitoring the entrance of a container during cargo loading in accordance with an embodiment of the invention.

FIG. 3 is a block diagram showing components of the intelligent switch shown in FIG. 2.

Reference will now be made to the drawings in which similar elements in different drawings bear the same reference numerals.

### DETAILED DESCRIPTION OF THE INVENTION

The invention is directed to methods of monitoring the loading of cargo into a shipping container using sensor fusion. If the sensor fusion results indicate a possible breach in security, an alarm signal is generated. In the case where cargo loading in foreign ports is being monitored, the alarm signal can be transmitted to an operations center via a satellite or GSM communications infrastructure. The use of sensor fusion reduces false alarms while increasing the overall security effectiveness.

One embodiment of the invention utilizes RFID technology, a camera with artificial intelligence (similar to the AIRA server included in the AIRA 2005 software package commercially available from Aimetis Corporation, Waterloo, Ontario, Canada), and data correlation software utilizing open source JXTA software to identify the presence of authorized/unauthorized handlers and cargo at the entrance to a shipping container. The camera utilizes artificial intelligence to construct a barrier (e.g., a 2-dimensional plane) around the cargo container's point of entry and detect people and items of cargo passing through this barrier. RFID technology identifies RFID tags on authorized cargo items as they pass through this barrier and also detects unique badges which identify the cargo handler. The data correlation software ties the two disparate systems together to infer knowledge to the integrity of the barrier and identify risks which can be later utilized by Customs and Border Protection to flag suspicious containers.

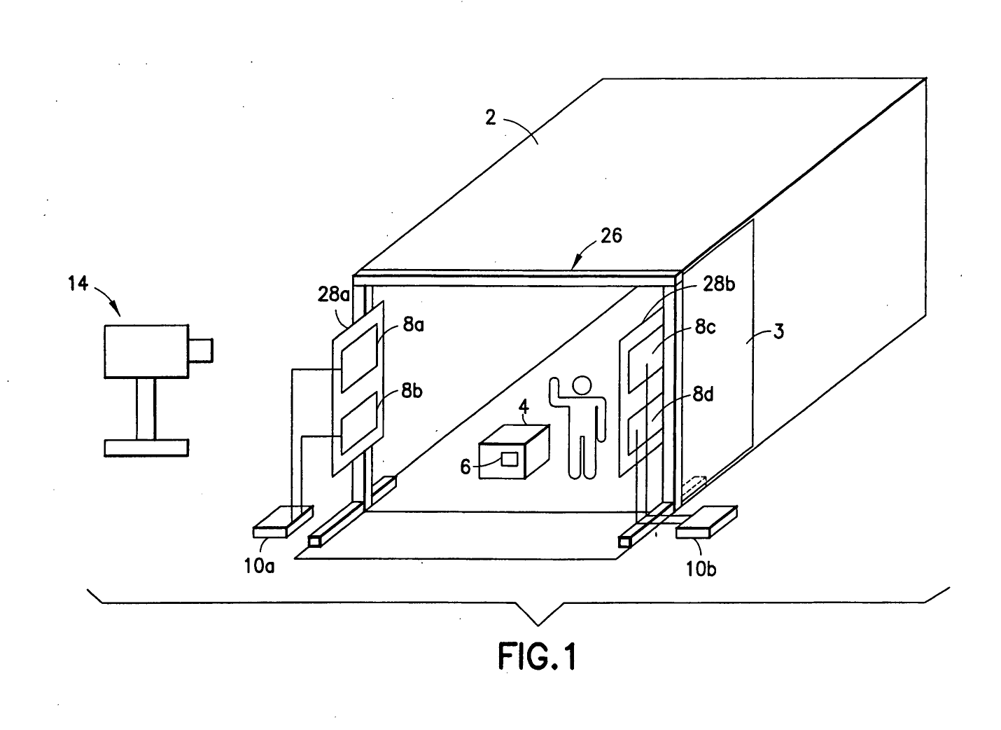

One embodiment of the invention is partly depicted in FIG. 1, which shows a shipping container 2 whose doors 3 (only one of which is visible) have been opened. The shipping container is box-shaped and has rectangular walls and floor and a rectangular entrance. During loading of the container, items of cargo are transported into the container by cargo handlers, either manually or using a machine. An item 4 of cargo has been placed inside the container. The cargo item 4 has a cargo RFID tag 6 attached thereto. Although not shown, the person standing beside the cargo item 4 in FIG. 1 may be provided with an RFID badge that identifies that person as an authorized cargo handler.

As depicted in FIG. 1, the camera of a video sensor 14 has a field of view aimed at the entrance to the cargo container 2. The video sensor 14 creates an entry record for each item of cargo and for each person that passes through a space at the entrance of the cargo container during any period of time.

In addition, a door frame 26 is placed at the container entrance. The door frame is configured so that a person or cargo item cannot enter the shipping container without passing between the side posts of the door frame. A first pair of scanning antennae 8a and 8b are mounted to a support board 28a attached to one post of the support frame 26; a second pair of scanning antennae 8c and 8d are mounted to a support board 28b attached to the other post of the support frame 26. The scanning antennae 8a and 8b are connected by wires to a first RFID reader 10a; the scanning antennae 8c and 8d are connected by wires to a second RFID reader 10b. The scanning antennae are used to interrogate each RFID tag or badge that enters the space at the entrance to the container. Each RFID reader comprises a transceiver with a decoder to interpret the RFID data. The transceiver transmits RF signals to the scanning antennae, which in turn output RF signals over a short range.

In accordance with one embodiment of the invention, each RFID tag or badge is of the passive variety. Each passive RFID tag or badge comprises a microchip combined with a coiled antenna in a compact package. When an RFID tag or badge passes through the field of a scanning antenna, the tag's (or badge's) antenna picks up RF signals output by the scanning antennae and then returns the signal with some additional data, such as a unique serial number or other customized information. More specifically, the coiled antenna forms an electromagnetic field, from which the RFID tag (or badge) draws power, thereby energizing its circuits. The tag then sends the identifying information encoded in the tag's memory.

Passive tags and badges function without a battery and therefore have long useful lives. Alternatively, the RFID tags and badges may be of the active type, meaning that each tag and badge is powered by its own battery Regardless of whether active or passive tags and badges are used, the antennae are configured and positioned to detect RFID signals transmitted from RFID tags and badges that enter the space at the entrance to the shipping container. The RFID signals detected by the antennae 8a and 8b are received and stored by RFID reader 10a; while the RFID signals detected by the antennae 8c and 8d are received and stored by RFID reader 10b. The RFID readers create an ID record for each RFID tag or badge that enters the space at the entrance of the cargo container during the time when video images are being acquired.

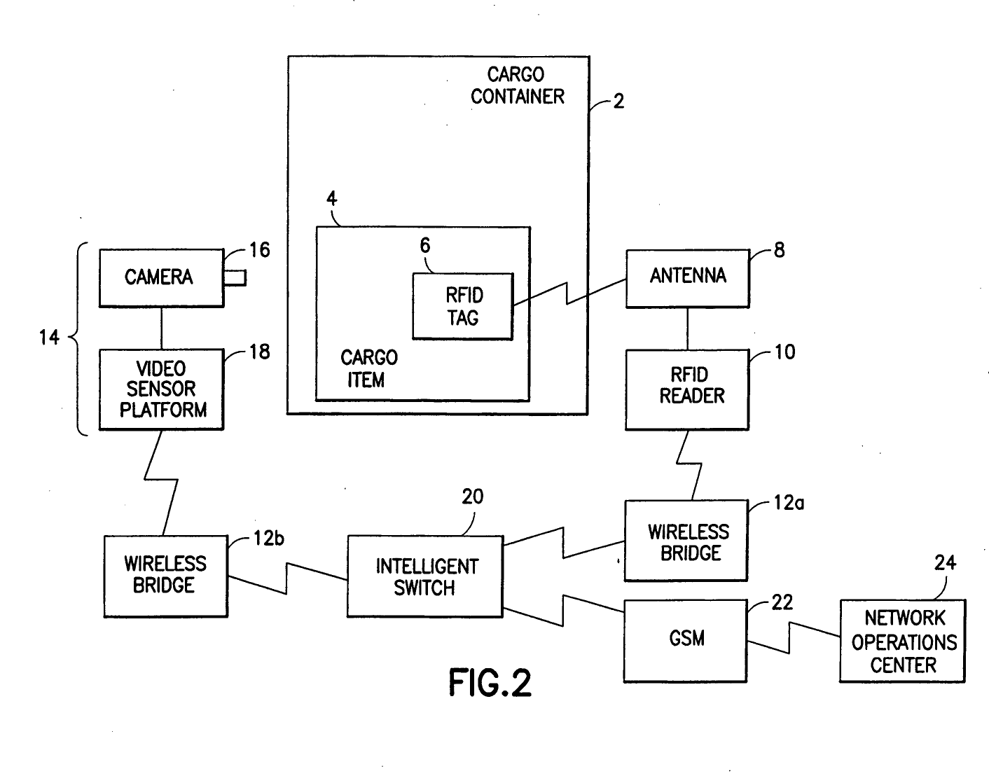

The main components of a cargo container monitoring system in accordance with one embodiment of the invention are shown in the block diagram of FIG. 2. The presence of an RFID tag 6 in the space at the entrance to the cargo or shipping container 2 is detected by a scanning antenna 8. The RFID signals from the RFID tag 6, which identify the item of cargo 4 to which the RFID tag 6 is attached, are decoded by an RFID reader 10. The resulting cargo ID data is sent to an intelligent switch 20 via a wireless bridge 12a. The cargo ID data from each tag that enters the shipping container is time-stamped with the time when the cargo ID data was acquired.

Similarly, the scanning antennae detect RFID badges being worn by authorized cargo handlers who enter and exit the shipping container. The RFID signals from the RFID badge (not shown in FIG. 2), which identify the person who should be wearing the RFID badge, are decoded by the RFID reader 10. The resulting personal ID data is also sent to the intelligent switch 20 via the wireless bridge 12a. The personal ID data from each badge that enters the shipping container is time-stamped with the time when the personal ID data was acquired.

The video sensor 14 comprises a video camera 16 having a field of view directed at the entrance to the cargo container 2. The video sensor 14 further comprises a video sensor platform 18 that creates a video record for each item of cargo that enters the cargo container. The video sensor platform comprises a software package that includes intelligent video analysis, digital video recording and remote access to live and recorded images from the network operations center. The video analysis software can automatically track and classify what entered the shipping container, i.e., whether cargo or personnel or both entered the shipping container during a certain interval of time. More specifically, entry data indicating that an item of cargo or a person or both are entering or have entered the shipping container is time-stamped with the time when the entry data was acquired. The results of this analysis (including, but not limited to, time-stamped cargo entry data and time-stamped person entry data) are transmitted to the intelligent switch 20 via the wireless bridge 12b.

As disclosed above, the ID and entry data (for both cargo and personnel) is wirelessly transmitted to an intelligent switch 20 programmed with data correlation software. Because both the ID data and the entry data are time-stamped, the intelligent switch 20 is able to correlate the ID data with the entry data and issue an alarm signal when the entry data does not correlate with the ID data. For example, alarm signals will be generated in response to the following events: (1) an item of cargo has entered the shipping container without an RFID tag attached thereto; and (2) a person has entered the shipping container who was not wearing an RFID badge. The intelligent switch may be further programmed with software that checks the validity of the RFID tags and badges, in which case the aforementioned alarm signals can be generated when a cargo item or a person has entered the container without an authorized RFID tag or with an unauthorized (e.g., counterfeit) tag or badge. The alarm signal may be transmitted by the intelligent switch 20 to a network operations center 24 via a GSM communications infrastructure (as shown in FIG. 2) or via a satellite communications infrastructure (not shown in FIG. 2).

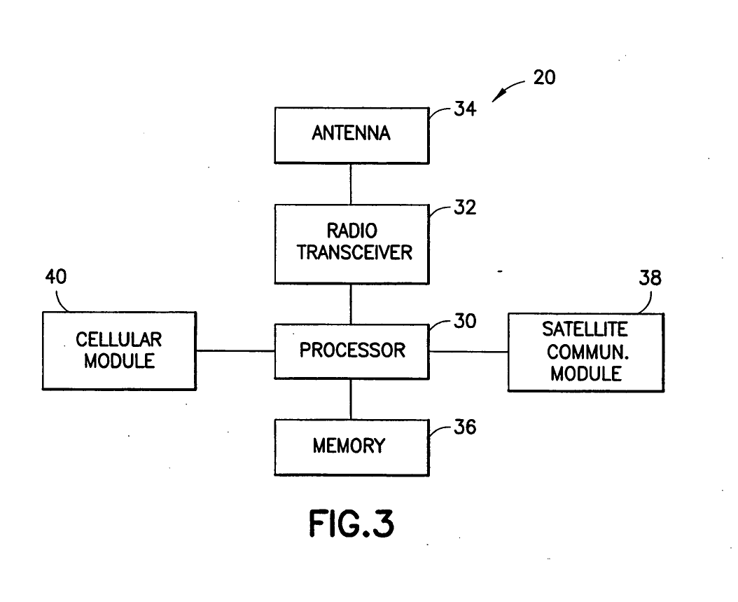

In accordance with the embodiment depicted in FIG. 3, the intelligent switch 20 comprises a processor 30 that controls a radio transceiver 32, a satellite communications module 38 and a cellular or GSM module 40. The intelligent switch 20 is programmed to serve as an interface between the sensors used to monitor a cargo container and the communications infrastructure. The intelligent switch 20 receives data from the wireless bridges (items 12a and 12b in FIG. 2) via a radio antenna 34 coupled to the transceiver 32. The processor 30 stores data in and retrieves data from memory 36. The processor 30 sends the alarm signal to a satellite via the satellite communications modem 38 or to a cellular tower via a cellular (i.e., GSM communications) modem 40.

Due to lean manufacturing principles in place in current supply chains, delays equate to production loss, storage fees, contract penalties, etc. for both suppliers and consumers, resulting in significant lost revenue. Securing the container's entry point with a verifiable solution, as disclosed above, ensures prompt delivery of goods by fast tracking the container through customs while also ensuring the protection of U.S. borders.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of ,monitoring an entrance to a cargo container, comprising the following steps:
(a) monitoring a space at the entrance of a cargo container to detect whether or not any object or any person has entered said space;
(b) transmitting a respective signal each time that any object or any person enters said space during step (a), each respective signal containing data indicating entry by a respective object or person;
(c) during step (a), monitoring said space to detect whether or not any authorization device has entered said space;
(d) transmitting a respective signal each time that any authorization device enters said space during step (c), each respective signal containing data indicating entry by a respective authorization device;
(e) receiving said transmitted signals at a data processor; and
(f) processing the data in said transmitted signals at said data processor to identify any lack of correlation between objects or persons and authorization devices entering said space.

2. The method as recited in claim 1, wherein said data processor transmits an alarm signal in response to identification of a lack of correlation.

3. The method as recited in claim 2, wherein said alarm signal is received at an operations center via a satellite or GSM communications infrastructure.

4. The method as recited in claim 1, wherein said transmitted signals are RF signals.

5. The method as recited in claim 1, wherein step (a) is performed by a video camera with artificial intelligence and a field of view directed at said entrance to said cargo container.

6. The method as recited in claim 1, wherein step (c) is performed by an RFID reader placed at or near said entrance to said cargo container.

7. The method as recited in claim 1, wherein said authorization devices are RFID tags.

8. A method of monitoring an entrance to a cargo container, comprising the following steps:
(a) creating an entry record for each item of cargo that passes through a space at the entrance of a cargo container during a period of time;
(b) creating an ID record for each RFID tag that enters said space during said period of time; and
(c) correlating said video and ID records to raise an alarm if an item of cargo passes through said space without an authorized RFID tag entering said space.

9. The method as recited in claim 8, further comprising the step of transmitting RF signals containing entry records and ID records respectively created during steps (a) and (b) to a device that performs step (c).

10. The method as recited in claim 8, wherein said entry records are created by applying artificial intelligence to video records, said video records being acquired by a video camera having a field of view directed at an entrance of said cargo container.

11. The method as recited in claim 8, further comprising the step of sending an alarm signal to an operations center via a satellite or GSM communications infrastructure.

12. A method of monitoring an entrance into a cargo container during loading, comprising the following steps:
(a) arranging a camera so that its field of view is directed at said entrance;
(b) arranging one or more antennae at or near said entrance;
(c) using said camera to acquire video data representing images of cargo entering or exiting said cargo container;
(d) processing said video data into cargo entry data indicating the entry of cargo into said cargo container;
(e) using said antennae to acquire cargo ID data from successive cargo RFID tags entering or leaving said cargo;
(f) correlating said cargo ID data with said cargo entry data; and
(g) transmitting an alarm signal if cargo without valid cargo ID data has been loaded into said cargo container.

13. The method as recited in claim 12, wherein step (e) comprises transmitting RF scanning signals from said antennae and across said entrance to cause passive RFID tags passing through said entrance to transmit respective RFID signals containing said cargo ID data.

14. The method as recited in claim 12, further comprising the step of transmitting RF signals containing cargo entry data and cargo ID data respectively acquired during steps (c) and (e) to a device that performs step (f).

15. The method as recited in claim 12, wherein step (d) is performed by a processor programmed with artificial intelligence and interfaced with said video camera.

16. The method as recited in claim 12, wherein said alarm signal is transmitted to an operations center via a satellite or GSM communications infrastructure.

17. An intelligent switch comprising:
means for receiving radio signals; and
a processor connected to said radio signal receiving means and programmed, after the radio signal receiving means has received radio signals including first data indicating times when items of cargo were loaded into a cargo container and radio signals including second data indicating times when authorized RFID tags entered the cargo container, to correlate said first data with said second data, and then issue an alarm signal if a cargo item has been loaded into the cargo container without entry of an authorized RFID tag into the cargo container.

18. The intelligent switch as recited in claim 17, further comprising a modem that enables wireless transmission of said alarm signal from said processor to a satellite.

19. The intelligent switch as recited in claim 17, further comprising a modem that enables wireless transmission of said alarm signal from said processor to a cellular tower.

20. The intelligent switch as recited in claim 17, further comprising memory connected to said processor, wherein said processor is further programmed to store alarm records in said memory and then retrieve said stored alarm records and transmit signals conveying said alarm records in response to an interrogation from an external source.
